(19) United States
(12) Patent Application Publication
(10) Pub. No.: US 2021/0320971 A1
(43) Pub. Date: Oct. 14, 2021

(54) Web Based Collaborative Music Playlist System

(71) Applicants: Alexander Lebowitz, York, PA (US); John Pike, Annapolis, MD (US)

(72) Inventors: Alexander Lebowitz, York, PA (US); John Pike, Annapolis, MD (US)

(21) Appl. No.: 17/226,672

(22) Filed: Apr. 9, 2021

Related U.S. Application Data
(60) Provisional application No. 63/007,648, filed on Apr. 9, 2020.

(51) Int. Cl. H04L 29/08; G06F 16/638; H04L 29/06; G06F 16/635

(52) U.S. Cl. CPC H04L 67/1046; G06F 16/639; H04L 65/1069; G06F 16/635; H04L 65/403; H04L 67/02; H04L 67/306; H04L 65/1073

(57) ABSTRACT

A web based collaborative music playlist application that the primary user, the Host, may use to generate a unique code to create a virtual room. This code may be shared with others who may then join the room as guests. Within the room, the guests may be able to request songs and the application may then queue the requests into a playlist, which may be edited by the host in real time. The host's device serves as the single point of communication between the room and a music service.

This application claims the benefit of U.S. Provisional Application No. 63/007,648, filed Apr. 9, 2020, and included herein by reference in its entirety.

### TECHNICAL FIELD OF THE INVENTION

The present invention relates to a web based collaborative music playlist application.

### BACKGROUND

Music applications such as Spotify and Apple Music allows users to digitally collect music and compile it into playlists, which may be shared. However, these playlists may only be accessed and utilized by users that subscribe to the same platform. Further, real-time playlist collaboration had been an absent feature on all major music applications (Spotify, Apple Music, and YouTube Music) during the creation of the invention herein described. As of April 2021, only Spotify has a real-time collaboration feature, and supports it only a beta test. Thus, unless users are subscribers of the same music application, they are unable to collectively queue songs or create or modify a real-time, collaborative playlist.

### DESCRIPTION OF THE FIGURES

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 is a block diagram illustrating how the system may include one or more web applications communicating with multiple backend microservices on a server, according to an embodiment.

FIG. 2 is a block diagram illustrating how a user may create a virtual room with a randomly generated Room Code, according to an embodiment.

FIG. 3 is a block diagram illustrating how a user may join an existing room, according to an embodiment.

FIG. 4 is a block diagram illustrating how the host of a room may modify the playlist, according to an embodiment.

FIG. 5 is a block diagram illustrating how a guest may modify the playlist by instructing the host to contact the server, according to an embodiment.

FIG. 6 is a block diagram illustrating how users may add new songs to the room, according to an embodiment

FIG. 7 is a block diagram illustrating how the software on the server automatically deletes rooms after a predefined amount of time, according to an embodiment.

### DETAILED DESCRIPTION

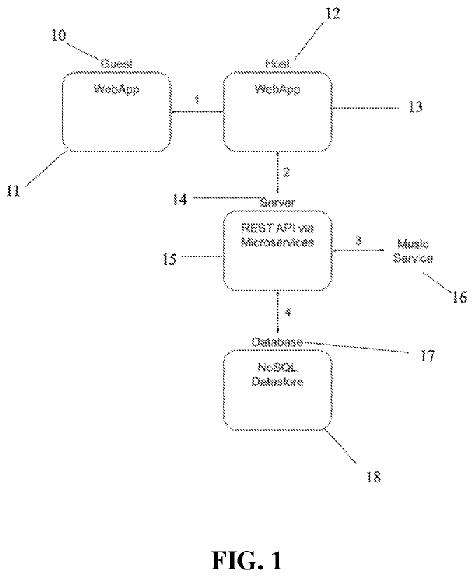

FIG. 1 illustrates an embodiment of the invention showing the system model where a guest device 10 interacts with the guest web application (WebApp) 11 and the host device 12 interacts with the host WebApp 13. (Note: In this discussion, the terms “guest” and host” refer to computing devices operated by users in guest and host capacities, respectively. Instances of a web app may be executing on these respective devices. These devices may be, for example and without limitation, smartphones, tablet computers, etc.) First, a WebSocket may serve as a channel for all communication between a guest and a host. A guest is “in” a Host's Room when they share an open WebSocket connection. Second, the host communicates with the server's (14) microservices 15 through a REST API. HTTP requests between the host and server enable all user functionality. Third, the server's (14) microservice 15 retrieves music from the music service 16 through an internet connection. Fourth, the server's microservices 15 create, update, and delete records in the database 17 via database-specific client software 18. The database 17 may represent the full state of the system including rooms, users, and song queues at any given time.

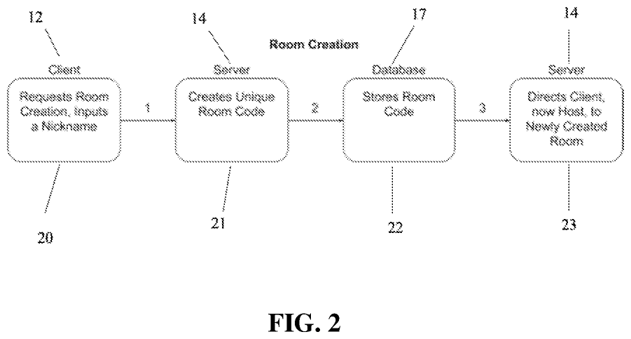

FIG. 2. illustrates an embodiment of the invention showing user functionality of the invention, specifically how to create a virtual room. The user 12 presses a button on the home page of the WebApp 13 and then submits their nickname. The WebApp 13 then sends a new room request containing the user's nickname to the server 14 and receives a response containing a randomly generated room code which is stored in the database 17. The WebApp 13 transitions to an empty room page, which displays the room code. The user 12 becomes the host and the host's WebApp opens a WebSocket to listen for Guest requests.

Thus, an implementation may consist of four stages, as illustrated in the embodiment of FIG. 2. First, the user's WebApp 13 uses a software library to send an HTTP POST request to a server 21 microservice. Second, a Golang program, “baux-backend,” may serve as the server 14 microservice 15 responsible for handling room creation. In sequence, the baux-backend will: (i) listen on a dedicated endpoint for a room creation request from the WebApp 13; (ii) create a new room upon receiving a POST request containing JavaScript Object Notation (JSON) data in the follow format: {“ReqType”:“NewRoom”,“ReqData”:{“HostNickname”:“My Nickname:}}; (iii) generate a random room code and verify its uniqueness against the database 17; (iv) store the following object in the database: {“HostNickname”:“My Nickname”,“RoomCode”:“xxxx”}; (iv) return the following object in a response to the WebApp: {“RoomCode”: xxxx}. Third, the user's WebApp 13 receives the room code response, which is displayed on the WebApp 13, and the user becomes the host. Fourth, the host's WebApp 13 leverages a client library for a WebSocket protocol (e.g., IETF RFC 6455). The host's WebApp 13 initializes a WebSocket connection to a server 14's microservice 15, “baux-ws”, to listen for requests from users or guests. The socket is identifiable by the host's room code.

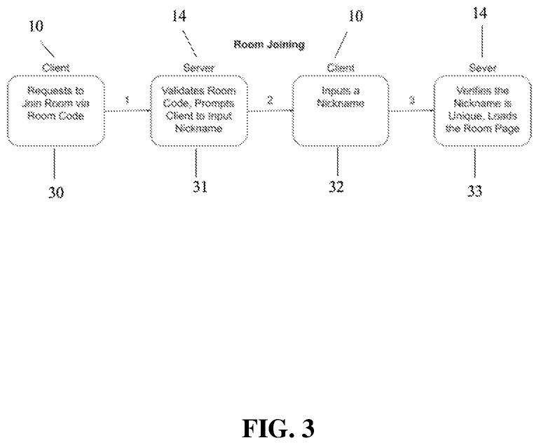

FIG. 3. illustrates an embodiment of the invention showing how a guest user's device 10 joins a room. Overall, the guest user 1 elects to join an existing room by pressing a button at the homepage of the WebApp 11. The user is prompted to enter the room code. The WebApp 11 then sends a join room request to the server 14, which verifies the validity of the room code. The user is prompted by the server 14 to input their nickname 32. The server then verifies the nickname and loads the room page where the user is now a guest.

The implementation of joining a room may be a two-step process. First, the guest user's WebApp 11 utilizes a WebSocket client to attempt to communicate with a host's WebApp 13. The user's WebApp 11 connects to the host's room by connecting to a WebSocket 9 identified by the user-supplied host's room code. The user then becomes a guest of the host's room. Second, the WebSocket remains open until the Guest disconnects. All future guest-host communication (i.e., modifying the playlist) will travel over the WebSocket connection.

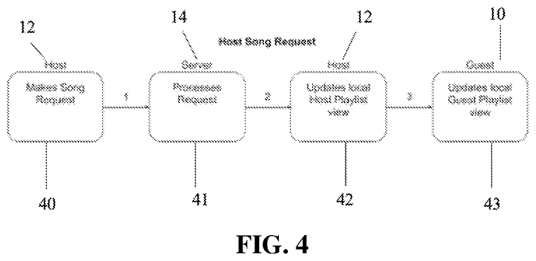

FIG. 4. illustrates an embodiment of the invention showing how a host 12 may modify the playlist. The host 12 modifies the playlist through user interface (UI) elements on the WebApp 13's room page. Host modifications include but are not limited to adding songs, deleting songs, reordering songs, and skipping songs. Since the host is the owner of the room, they are allowed to modify the playlist via direct communication with the server 14. The modification of the playlist is implemented in five steps. First, the host 12 interacts with the WebApp 13 through a UI element 40. Second, the WebApp instance resolves the interaction to an encoded JSON object and sends an HTTP POST request to a Server microservice 15. Third, a Golang program, “baux-yt”, is one of the Server 14's microservices 15, responsible for translating requests into music service data 41. Music service data may include playable audio streams, album art, etc. If the modification is a new song request, baux-yt will execute four steps: (i) listen on a dedicated endpoint for requests from the host's WebApp 13; (ii) recognize playlist modification upon receiving a POST request containing JSON data, depending on the type of request, in a similar format to: {“SongsIn”:[My Song Title by My Artist” ], “User”:“My Nickname”}; (iii) use the music service's API to translate the JSON data into usable data; and (iv) send a response to the host's WebApp 13 in a similar format to the following: {“song_urls”:[https://www.mymusicservice.com/songIdExample?i=123456abcde fg], “user”:“My Nickname”}. The fourth step for implementation depends on the modification, but essentially the host's WebApp 13 receives the baux-yt response and/or updates its local playlist view with the new song's data 42. The fifth and final step in the implementation is the host's broadcast of the new playlist, encoded as a JSON object, over its WebSocket connection. All guests in the room receive the message and each guest WebApp 11 updates itself to reflect the modification to the playlist.

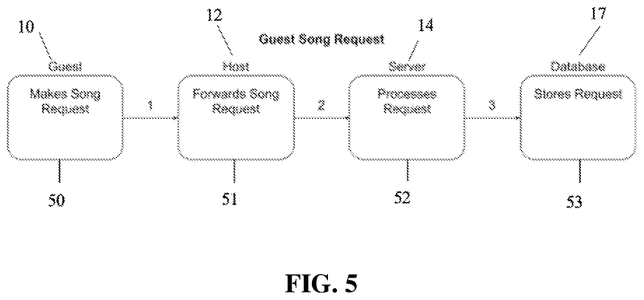

FIG. 5. illustrates an embodiment of the invention where a guest may modify a playlist. A guest may modify the playlist through UI elements on the WebApp's room page. Guest modification options will be a subset of host modification options. Since the room is controlled by the host and not by the guest, the guest must communicate through the host 12 in order to contact the server 14. Thus, the host remains the single point of contact with the music service. The guest modification of the playlist is implemented in a few steps. First, the guest interacts with the WebApp through a UI element 50. Second, the WebApp resolves the interaction to an encoded JSON object and broadcasts it over the host's WebSocket connection. Third, the host receives the request and forwards the song or an identifier of the song to the server 12, which then processes the request 52 and updates the local host playlist view 53 and the local guest playlist view.

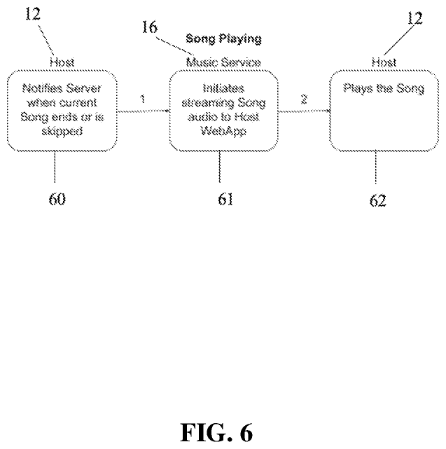

FIG. 6. illustrates an embodiment of the invention where songs are played through the WebApp. As songs are added to the room's queue, the music service will play them in the order they were added or reordered. First, the host's WebApp 13 detects a manual “next song” event if the host skips the song or an automatic event if the song plays as scheduled from the music service API. Second, the host's WebApp 13 retrieves the next song's data from the playlist and requests to stream audio from the Music Service API. Thus, the host notifies the server when a current song ends or is skipped 60. Then the music service initiates streaming the song audio to the Host WebApp 13. Finally, the host plays the song 62 for the guests.

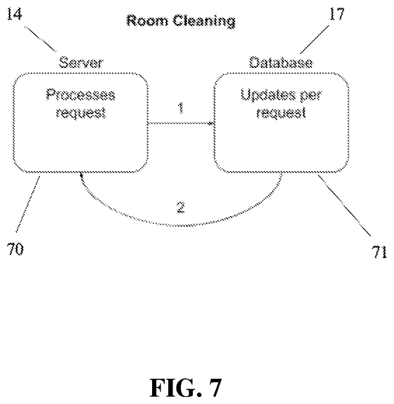

FIG. 7. illustrates an embodiment of the invention where the virtual room is automatically deleted by the server. The virtual rooms utilized by the WebApp are temporary and are automatically deleted by the server after a predefined amount of time. The program responsible for hosting WebSockets, “baux-ws”, is the Server microservice which ages-off old rooms. In sequence, baux-ws will continually: query the database to delete rooms with an age greater than 24 hours; notify any WebApp clients in deleted rooms that the room has expired; and sleep for 60 seconds. Thus, the server processes the request 70 and the database updates per request 71. In an alternative embodiment, the time limit may be a value other than 24 hours. In an embodiment, the time limit may be configurable by the host or other authorized entity.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method, performed at a server, comprising:
creating a virtual room;
admitting one or more guests to the virtual room;
modifying a playlist; and
facilitating playing a song,
wherein the guests are not all subscribers to a single particular music platform.

2. The method of claim 1, wherein said virtual room is created by a server microservice, said creating of said virtual room comprising:
listening for a room creation request from a WebApp;
receiving a request containing at least the following data:
{“ReqType”:“NewRoom”, “ReqData”:{“HostNickname”;“My Nickname”}};
generating a random room code “RoomCode”:“xxxx”; and
verifying uniqueness of the random room code against a database storing {“HostNickname”:“My Nickname”, “RoomCode”:“xxxx”} in the database; and
returning {“RoomCode”: xxxx} to the WebApp, making a user of the WebApp a host.

3. The method of claim 1, wherein the admitting of guests to the virtual room comprises:
receiving a join room request from a user;
verifying the validity of a room code associated with the join room request;
prompting the user to input a user nickname;
verifying the user nickname; and
loading a room page of the associated room code.

4. The method of claim 1, wherein modifying the playlist comprises:
receiving, from a host, a request at a microservice of the server;
translating the request into associated music service data;
updating the playlist consistent with the associated music service data;
updating a view of the playlist; and
broadcasting the updated playlist to the virtual room.

5. The method of claim 1, wherein modifying of the playlist comprises:
receiving, from the guest via a host, a request at a microservice of the server;
translating the request into associated music service data;
updating the playlist consistent with the associated music service data;
updating a view of the playlist; and
broadcasting the updated playlist to the virtual room.

6. The method of claim 1, wherein playing of the song comprises:
receiving from a host a notification that a current song is ending or is skipped; and
allowing retrieval of information associated with the song from the playlist.

7. The method of claim 1, further comprising deleting the virtual room, said deleting comprising:
querying a database to determine if the virtual room is older than a predetermined threshold;
when the virtual room is older than the predetermined threshold, notifying clients in the virtual room that the virtual room is expired; and
updating the database regarding the expiration.

8. A system comprising a server that includes a programmable processor and a memory, the memory comprising computer readable instructions that, when executed by the processor, cause the server to perform the following:
creating a virtual room;
admitting one or more guests to the virtual room;
modifying a playlist; and
facilitating playing a song,
wherein the guests are not all subscribers to a single particular music platform.

9. The system of claim 8, wherein said virtual room is created by a server microservice, said creating of said virtual room comprising:
listening for a room creation request from a WebApp;
receiving a request containing at least the following data:
{“ReqType”:“NewRoom”, “ReqData”:{“HostNickname”;“My Nickname”}};
generating a random room code “RoomCode”:“xxxx”; and
verifying uniqueness of the random room code against a database storing {“HostNickname”:“My Nickname”, “RoomCode”:“xxxx”} in the database; and
returning {“RoomCode”: xxxx} to the WebApp, making a user of the WebApp a host.

10. The system of claim 8, wherein the admitting of guests to the virtual room comprises:
receiving a join room request from a user;
verifying the validity of a room code associated with the join room request;
prompting the user to input a user nickname;
verifying the user nickname; and
loading a room page of the associated room code.

11. The system of claim 8, wherein the modifying of the playlist comprises:
receiving, from a host, a request at a microservice of the server;
translating the request into associated music service data;
updating the playlist consistent with the associated music service data;
updating a view of the playlist; and
broadcasting the updated playlist to the virtual room.

12. The system of claim 8, wherein modifying of the playlist comprises:
receiving, from the guest via a host, a request at a microservice of the server;
translating the request into associated music service data;
updating the playlist consistent with the associated music service data;
updating a view of the playlist; and
broadcasting the updated playlist to the virtual room.

13. The system of claim 8, wherein the playing of the song comprises:
receiving from a host a notification that a current song is ending or is skipped; and
allowing retrieval of information associated with the song from the playlist.

14. The system of claim 8, wherein the memory comprises further instructions that when executed by the processor, causes the server to delete the virtual room, said deleting comprising:
querying a database to determine if the virtual room is older than a predetermined threshold;
when the virtual room is older than the predetermined threshold, notifying clients in the virtual room that the virtual room is expired; and
updating the database regarding the expiration.
